(19) United States
(12) Patent Application Publication
(10) Pub. No.: US 2014/0198635 A1
(43) Pub. Date: Jul. 17, 2014

(54) METHOD OF RECOVERING FAULT IN MULTILAYER NETWORK AND APPARATUS THEREOF

(71) Applicant: Electronics and Telecommunications Research Institute, Daejeon-si (KR)

(72) Inventors: Kyeong-Eun HAN, Daejeon-si (KR); Sun-Me KIM, Daejeon-si (KR); Tae-Hyun KWON, Gyeongsangbuk-do (KR); Tae-Il KIM, Daejeon-si (KR); Jong-Hyun Lee, Daejeon-si (KR)

(73) Assignee: Electronics and Telecommunications Research Institute, Daejeon-si (KR)

(21) Appl. No.: 14/014,451

(22) Filed: Aug. 30, 2013

(30) Foreign Application Priority Data
Jan. 16, 2013 (KR) 10-2013-0005059

(51) Int. Cl. H04L 12/703; H04L 12/723

(52) U.S. Cl. CPC H04L 45/28; H04L 45/50
USPC 370/228

(57) ABSTRACT

A method of recovering a fault in a multilayer network and an apparatus thereof are provided, the method including obtaining lower layer backup path setting information through a signaling message that is used for a label based path setting, setting a backup path at a lower layer based on the obtained lower layer backup path setting information, and upon detecting a fault at the lower layer, performing a protection switching through the set backup path at the lower layer.

### CROSS-REFERENCE TO RELATED APPLICATION

This application claims the benefit under 35 U.S.C. §119(a) of a Korean Patent Application No. 10-2013-0005059, filed on Jan. 16, 2013, in the Korean Intellectual Property Office, the entire disclosure of which is incorporated herein by reference for all purposes.

### BACKGROUND

1. Field

The following description relates to a multilayer network, and more particularly, to a technology for recovering a fault in a multilayer network having multilayer label switched paths (LSP).

2. Description of the Related Art

In general, when a label switched path (hereinafter, referred to as an LSP) is set, a multiprotocol label switching (hereinafter, referred to as MPLS) based network collects interface information for each layer and independently performs a routing for each layer. Accordingly, if an available resource is not present at the time of setting an LSP based on the interface for each layer, the setting of a corresponding LSP is failed.

In contrast, a multilayer network, if an available resource to set an LSP at a current layer is not present, performs a lower layer routing based on an interface of a lower layer, and if an available resource is present at the lower layer, sets an LSP at the lower layer first. As a physical or logical interface is generated according to the above, a newly set interface information is registered, and thus an LSP setting at an upper layer becomes possible. Such a multilevel LSP setting shares interface information of the respective layers and performs a stepwise LSP setting, which enables the effective use of resources.

At the present time, the multilayer network sets a backup LSP only at an upper layer, and does not set a backup LSP at a lower layer. In this case, if a fault occurs at an intermediate node of a lower layer LSP, fault information is notified to a source node and a protection recovery is performed through an upper layer backup LSP that is set in advance. Such a method delays the protection recovery time in a case where the number of intermediate nodes is great, and has a disadvantage that fault information needs to be transmitted to the upper layer even if the fault occurs at the lower layer.

### SUMMARY

The following description relates to a method of recovering a fault, capable of performing a recovery in an efficient and rapid manner in a multilayer network including multilevel LSPs, and an apparatus thereof.

In one general aspect, a method of recovering a fault in a multilayer network includes obtaining lower layer backup path setting information through a signaling message that is used for an LSP setting, setting a backup path at a lower layer based on the obtained lower layer backup path setting information, and upon detecting a fault at the lower layer, performing a protection switching through the set backup path at the lower layer.

The lower layer backup path setting information may include information whether to set a backup path at a lower layer, information about a protection recovery type, and information about a processing method at a failure of the setting of a backup path at a lower layer. The information whether to set the backup path at the lower layer may be divided into a no-setting of a backup path at a lower layer, a setting of a backup path at a lower layer if an available resource for setting the path is present when the backup path at the lower layer is set, a no-setting of a backup path at a lower layer if an available resource for setting the path is not present when the backup path at the lower layer is set, and a failure of an entire path setting if the setting of the backup path is failed due to an absence of an available resource when the backup path at the lower layer is set. The lower layer backup path setting information may be defined in a data frame format.

The setting of the backup path at the lower layer may include setting a working path at a lower layer, transmitting a path setting failure message to a transmitting node if the setting of the working path at the lower layer is failed, and determining whether to set a backup path at the lower layer if the setting of the working path is successful, setting the backup path at the lower layer based on the information about a protection recovery type if determined to set the backup path at the lower layer, and transmitting a path failure message to the transmitting node if the setting of the backup path at the lower layer is failed.

The performing of the protection switching may include, if a fault at a lower layer is sensed, determining whether a backup path is set at a lower layer, and if the backup path at the lower layer is set, performing a protection switching through the backup path at the lower layer, and if the backup path at the lower layer is not set, performing a protection switching through a backup path at an upper layer.

In the setting of the backup path at the lower layer, if a lower layer backup path no-setting option is set in the obtained lower layer backup path setting information, the backup path may not be set at the lower layer.

In the setting of the backup path at the lower layer, if a lower layer backup path setting option is set in the obtained lower layer backup path setting information, it may be determined whether an available resource required to set the path at the time of setting the backup path at the lower layer is present, and if the available resource is present, the backup path may be set at the lower layer, and if the available resource is not present, the backup path may not be set at the lower layer.

In the setting of the backup path at the lower layer, if the setting of the backup path is failed due to the absence of an available resource required to set the path at the time of setting the backup path at the lower layer, an entire path setting may be determined to be failed and a path setting failure message is transmitted to a transmitting node.

In another general aspect, an apparatus for recovering a fault in a multilayer network includes a signaling process unit, a path setting unit, and a protection switching unit. The signaling process unit may be configured to analyze lower layer backup path setting information of a received signaling message. The path setting unit may be configured to set a backup path at a lower layer based on the lower layer backup path setting information that is analyzed through the signaling process unit. The protection switching unit may be configured, if a fault at the lower layer is sensed, to perform a protection switching through the backup path of the lower layer that is set through the path setting unit.

The lower layer backup path setting information may include information whether to set a backup path at a lower layer, information about a protection recovery type, and information about a processing method at a failure of the setting of a backup path at a lower layer.

The information whether to set the backup path at the lower layer may be divided into a no-setting of a lower layer backup path, a setting of a lower layer backup path if an available resource for setting the path is present when the backup path at the lower layer is set, a no-setting of a lower layer backup path if an available resource for setting the path is not present when the backup path at the lower layer is set, and a failure of an entire path setting if the setting of the backup path is failed due to an absence of an available resource when the backup path at the lower layer is set.

The path setting unit may be configured to set a working path at a lower layer, transmit a path setting failure message to a transmitting node if the setting of the working path at the lower layer is failed, determine whether to set a backup path at the lower layer if the setting of the working path is successful, set the backup path at the lower layer based on information about a protection recovery type if determined to set the backup path at the lower layer, and transmit a path failure message to the transmitting node if the setting of the backup path at the lower layer is failed.

The protection switching unit, if a fault at a lower layer is sensed, may be configured to determine whether a backup path is set at a lower layer, and if the backup path at the lower layer is set, perform a protection switching through the backup path at the lower layer, and if the backup path at the lower layer is not set, perform a protection switching through a backup path at an upper layer.

As apparent from the above, when an LSP is set at a lower layer, it is determined whether to set a backup LSP (BLSP), and if determined to set the BLSP, the BLSP is set at the lower layer. In addition, when an LSP is set, a lower layer backup LSP setting information is transmitted through a RSVP signaling message, so that the backup LSP setting at the lower layer and a protection recovery at the occurrence of a fault can be automatically performed by use of the lower layer backup LSP setting information.

In addition, when a fault occurs at a multilayer network including multilevel LSPs, the fault recovery is performed through a lower layer backup LSP without notifying a source node of fault information to recover the fault through an upper layer backup LSP, so that the packet loss and the time delay for fault recovery are reduced, thereby responding to the fault in a rapid manner.

Other features and aspects will be apparent from the following detailed description, the drawings, and the claims.

### BRIEF DESCRIPTION OF THE DRAWINGS

FIG. 1 is a diagram illustrating an example of setting an LSP at a multilayer network applied with the present disclosure.

FIG. 2 is a flowchart showing a method of setting a backup LSP at a lower layer and recovering a fault when a fault occurs in accordance with an embodiment of the present disclosure.

FIG. 3 is a diagram illustrating a configuration of an attribute format of a lower layer backup LSP setting in accordance with an embodiment of the present disclosure.

FIG. 4 is a diagram illustrating a configuration of a TLV format of lower layer backup LSP setting information in accordance with an embodiment of the present disclosure.

FIG. 5 is a flowchart showing a method of setting a backup LSP at a lower layer in accordance with an embodiment of the present disclosure.

FIG. 6 is a diagram illustrating a configuration of a protection switching apparatus in a multilayer network in accordance with an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. In addition, terms described below are terms defined in consideration of functions in the present invention and may be changed according to the intention of a user or an operator or conventional practice. Therefore, the definitions must be based on content throughout this disclosure.

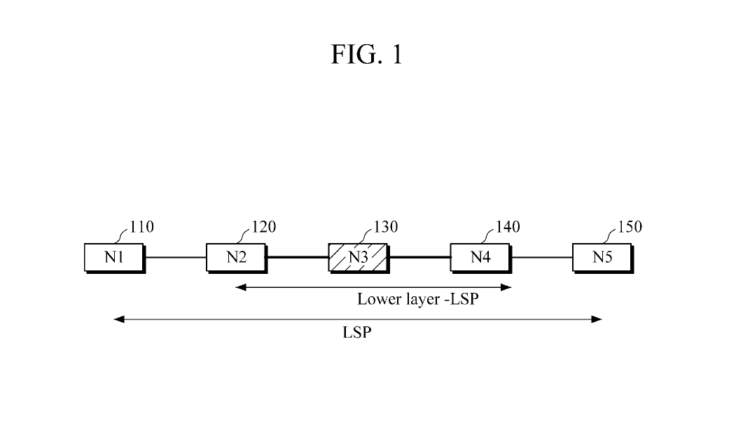

FIG. 1 is a diagram illustrating an example of setting an LSP at a multilayer network applied with the present disclosure.

Referring to FIG. 1, a multilayer network includes multiple layers, for example, the multiple layers are divided into a lower layer and an upper layer in terms of levels, and the dividing of the layers is determined as relative to a current layer.

The multilayer network includes nodes each representing a network device. In FIG. 1, a N1 node 110 to a N5 node 150 are illustrated as an example. Each of the nodes 110, 120, . . . , and 150 manages a resource of at least one layer among multiple layers. Each of the nodes 110, 120, . . . , and 150 operates as a management system to manage resources between layers.

A label switched path (hereinafter, referred to as an LSP) representing a forwarding path may be set between nodes, and a packet is transmitted through the set LSP. There is a signaling protocol that is transmitted to all nodes on the LSP to reserve resources. The signaling protocol may be a resource reservation protocol (hereinafter, RSVP). The RSVP transmits/receives a path message and a Resv message between nodes, thereby setting a path used to transmit traffic. For the convenience of description, the following description will be made in relation to the RSVP.

The present disclosure relates to (1) a method of transmitting a lower layer backup LSP setting information through a RSVP signaling message, (2) a method of determining a frame format of information about setting a lower layer backup LSP, (3) a method of setting a lower layer backup LSP, and (4) a method of recovering a fault when a fault occurs in a lower layer in a multilayer network apparatus including multilevel LSPs and a system thereof.

In accordance with an embodiment of the present disclosure, it is assumed that LSPs from the N1 node 110 to the N5 node 150 represent forward paths set at layer 3, and there is no available resource of layer 3 interface connected from the N2 node 120 to the N5 node 150. When the N1 node 110 representing a source node desires to establish an LSP with the N5 node 150 representing a destination node to transmit data therebetween, the N1 node 110 calculates a transmission path (N1-N2-N4-N5) by performing a routing based on interface information that is collected in advance, and transmits a path message representing a RSVP signaling message to is the N2 node 120.

Similar to the N1 node, the N2 node 120 performs a routing based on interface information collected at layer 3, but there is no available interface connected to the N4 node 140 representing a next node. Accordingly, the N2 node 120 holds the RSVP signaling message, and checks whether an available resource capable of setting an LSP to the N4 node 140 is present in layer 2 that is a lower layer with respect to the N2 node 120. If the available resource is present, the N2 node 120 sets a new lower layer LSP (N2-N3-N4) from the N2 node 120 to the N4 node 140. On the contrary, if the available resource is not present in layer 2, the N2 node 120 checks whether an available resource is present at layer 1 that is a lower layer with respect to layer 2, and if the available resource is present, the N2 node 120 sets a LSP at layer 1. If an available resource for setting an upper layer LSP is not present even at the lower most layer, the LSP setting is regarded as a failure, and a path error message representing a path setting failure message is transmitted to the N1 node 110 representing the source node.

After the lower layer LSP setting is completed, the N2 node 120 sets a hierarchy LSP based on the lower layer LSP. That is, a lower layer LSP is first set, and an upper layer LSP is set on the lower layer LSP, and then a RSVP message is transmitted to the N4 node 140. In the above embodiment, two hierarchy LSPs are generated. The first hierarchy LSP is N2-N3-N4, and the second hierarchy LSP is N1-N2-N4-N5. As the resource and interface information are shared by setting the multilevel LSPs as described above, the LSP setting failure is minimized and an efficient data transmission is achieved.

In accordance with the present disclosure, when a LSP is set at a lower layer, it is determined whether to set a backup LSP (BLSP), and if determined to set the BLSP, the BLSP at the lower layer is set. In addition, a transmitting node transmits lower layer backup LSP setting information to a receiving node through a RSVP signaling message, such that the receiving node automatically performs a lower layer backup LSP setting as well as a protection recovery at the occurrence of a fault by use of the lower layer backup LSP setting information.

Further, in a case in which a fault occurs at a multilayer network including multilevel LSPs, it is not that the fault is recovered through an upper layer backup LSP by notifying a source node of fault information, but that a partial recovery is performed through a lower layer backup LSP, so that a packet loss and a delay time for recovering the fault are reduced, thereby responding to the fault in a rapid manner.

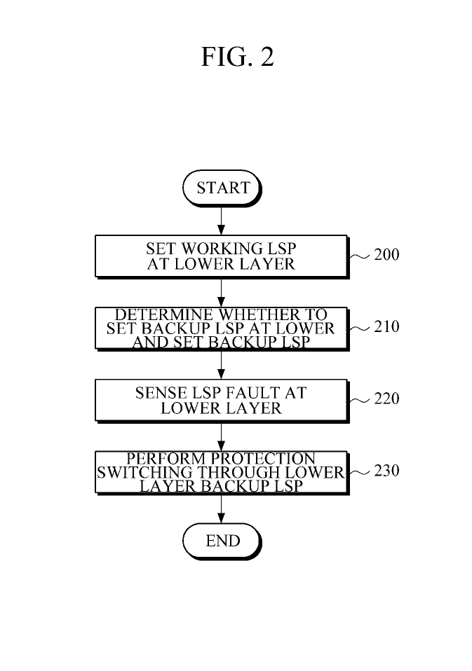

FIG. 2 is a flowchart showing a method of setting a backup LSP at a lower layer and recovering a fault when a fault occurs in accordance with an embodiment of the present disclosure.

Referring to FIG. 2, a lower layer working LSP is set in operation 200, and if a RSVP signaling message including lower layer backup LSP setting information is received from a transmitting node, it is determined whether to set a backup LSP based on the received lower layer backup LSP setting information, and a backup LSP is set based on information about a protection recovery type used to set the backup LSP in operation 210.

If a LSP fault is sensed at a lower layer in operation 220, it is determined whether a backup LSP is set at the lower layer, and if the backup LSP is set at the lower layer, a protection switching is performed through the backup LSP at the lower layer without ascending to an upper layer in operation 230. On the contrary, if the backup LSP is not set at the lower layer, a protection switching is performed through a backup LSP at an upper layer. In this case, the respective layers may be formed as hierarchy lower layers leading to the lowermost layer. That is, the lower layer is determined as relative to a current layer.

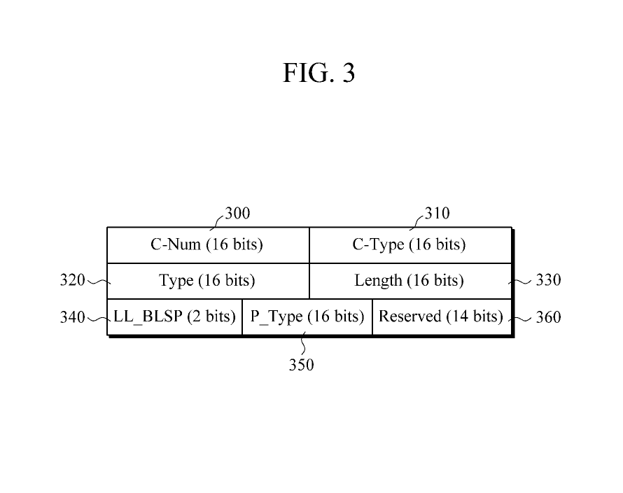

FIG. 3 is a diagram illustrating a configuration of an attribute format of a lower layer backup LSP setting in accordance with an embodiment of the present disclosure.

In detail, FIG. 3 shows an embodiment of an attribute format of a lower layer backup LSP setting that is included in an independent attribute of a RSVP signaling message to notify whether to set a lower layer backup LSP while transmitting additional information for the setting.

A C-Num field 300 of the attribute format of the lower layer backup LSP setting distinguishes an attribute value included in an RSVP message. A C-Type field 310 indicates a TLV value of attribute distinguished by the C-Num. Since one attribute may include a plurality of TLVs, a Type field 320 is used to distinguish each TLV. That is, the Type field 320 in accordance with the present disclosure is set as a TLV value used to set a lower layer backup LSP. A Length field 330 is a field representing the entire size of a TLV, and includes sizes of the Type field 320, a Length field 330, a LL_BLSP field 340, and a P_Type field 350. A Reserved field 360 is padded with zero.

The LL_BLSP field 340 may have a size of 2 bits, and indicate whether to set a lower layer backup LSP while indicating a lower layer backup LSP setting option. In accordance with an embodiment of the present disclosure, the value of <00> of the LL_BLSP field 340 indicates that the lower layer backup LSP is not set, and when the lower layer backup LSP is set, the value of <10> of the LL_BLSP field 340 indicates that the lower layer backup LSP is set if an available resource is present and that the lower layer backup LSP is not set if an available resource is not present, and the value of <11> of the LL_BLSP field 340 indicates that an entire LSP setting is failed if the setting of the backup LSP is failed due to the absence of an available resource when the lower layer backup LSP is set.

The P_Type field 350 indicates a protection recovery type applied when the backup LSP is set. In accordance with an embodiment of the present disclosure, depending on the value of the P_Type field 350, recovery schemes 1:1, 1+1, M:N, and 1:N are selected. In this case, the sizes of the fields 340 and 350 related to the lower layer backup LSP setting may be defined depending on the circumference of the network.

The 1:1 scheme is a recovery scheme in which one backup path is allocated to one working path. In order to prevent waste of resources allocated to backup paths, the 1:N scheme is provided to allow one backup path to be shared among other working paths. The 1:N scheme is extended to the M:N scheme capable of recovering a multi-link fault. When a fault occurs, a protection switching of traffic is performed through the backup path.

The 1+1 scheme is similar to the 1:1 scheme in that a backup path is provided for one working path, but is characterized in that the same data is transmitted not only through a use path but also through an alternative path. That is, a receiving end receives the same data through two paths.

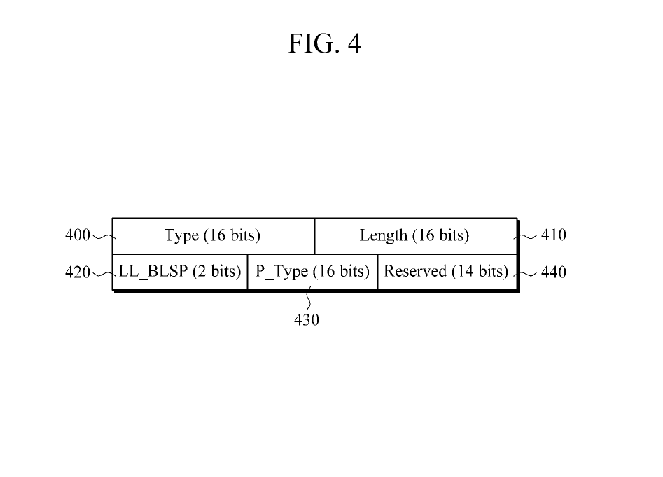

FIG. 4 is a diagram illustrating a configuration of a TLV format of a lower layer backup LSP setting information in accordance with an embodiment of the present disclosure.

In detail, FIG. 4 shows an embodiment of a format that is defined when a lower layer backup LSP setting information is included in a TLV of an LSP_ATTRIBUTE or an LSP_REQUIRED_ATTRIBUTES of an RSVP signaling message.

Since the LSP_ATTRIBUTE or LSP_REQUIRED_ATTRIBUTES may include a plurality of TLVs, a Type field 400 has a TLV ID value to set the lower layer backup LSP. A Length field 410 has a value corresponding to sizes of the Type 400, Length 410, LL_BLSP 420, and P_Type 430. The descriptions of the LL_BLSP 420, P_Type 430, and Reserved 440, which represent fields related to the lower layer backup LSP setting, are identical to the above descriptions of FIG. 3, and therefore will be omitted.

Meanwhile, the above embodiment described with reference to FIGS. 3 and 4 are illustrated only as an example of the present disclosure, and information whether to set a lower layer backup LSP, information about a protection recovery type, and information about a processing method at the failure of the setting of the lower layer backup LSP may be delivered through explicit or connotative connection of at least one of thereof, and may be defined in a separate frame format including these information.

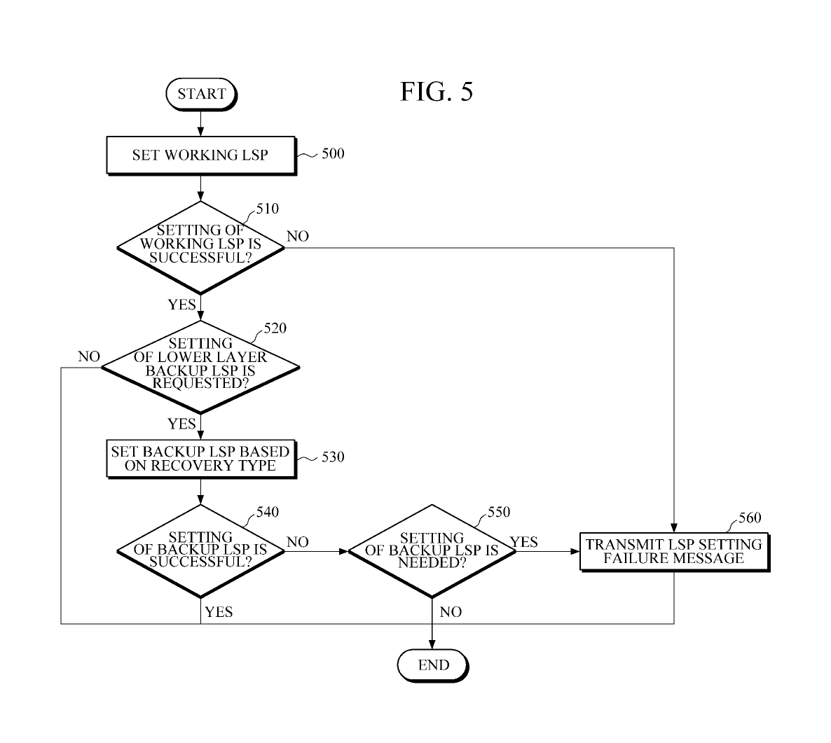

FIG. 5 is a flowchart showing a method of setting a backup LSP at a lower layer in accordance with an embodiment of the present disclosure.

First, if an LSP setting at a lower layer is determined, a corresponding node sets a working LSP in operation 500. Subsequently, it is determined whether the setting of the working LSP is successful in operation 510, and if the setting of the working LSP setting is not successful, an upper layer LSP setting is also regarded as a failure and thus a LSP setting failure message is sent to a source node in operation 560.

On the contrary, if the setting of the working LSP is successful, it is determined whether a lower layer backup LSP is to be set in operation 520 and a backup LSP setting is needed in operation 550, and a backup LSP is set depending on a protection recovery type in operation 530. Depending on the format of the lower layer backup setting information, operation 520 and operation 550 may be identified through a single piece of information, or as shown in FIG. 5, may be identified through separated pieces of information. If determined from operation 550 that the setting of the backup LSP is needed and the backup LSP setting is failed, the lower layer LSP setting is regarded as a failure and thus an LSP failure message is transmitted in operation 560, and the setting ends.

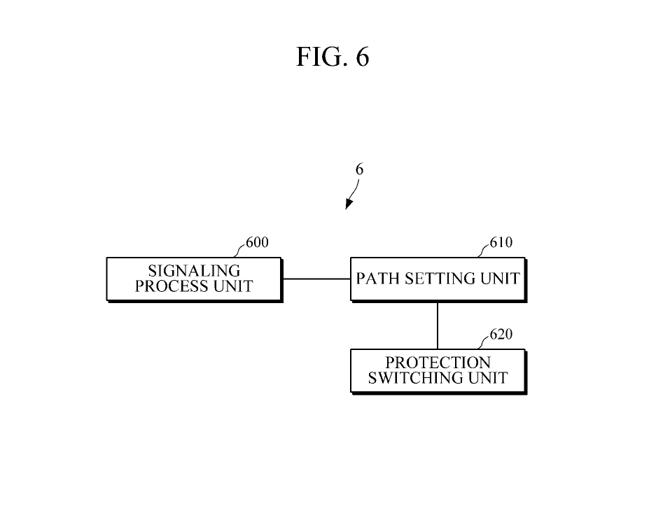

FIG. 6 is a diagram illustrating a configuration of a protection switching apparatus 6 in a multilayer network in accordance with an embodiment of the present disclosure.

Referring to FIG. 6, the protection switching apparatus 6 includes a signaling process unit 600, a path setting unit 610, and a protection switching unit 620. The protection switching apparatus 6 may be located on a node of a multilayer network.

The signaling process unit 600 analyzes a lower layer backup path setting information of a received signaling message. The lower layer backup path setting information may include information whether to set a backup path at a lower layer, information about a protection recovery type, and information about a processing method at a failure of the setting of a backup path at a lower layer. The information whether to set the backup path at the lower layer is divided into a no-setting of a lower layer backup path, a setting of a lower layer backup path if an available resource for setting the path is present when the backup path at the lower layer is set, a no-setting of a lower layer backup path if an available resource for setting the path is not present when the backup path at the lower layer is set, and a failure of an entire path setting if the setting of the backup path is failed due to an absence of an available resource when the backup path at the lower layer is set.

The path setting unit 610 sets the backup path at the lower layer based on the lower layer backup path setting information that is analyzed through the signaling process unit 600. In accordance with an embodiment of the present disclosure, the path setting unit 610 sets a working path at a lower layer, transmits a path setting failure message to a transmitting node if the setting of the working path at the lower layer is failed, and determines whether to set a backup path at the lower layer if the setting of the working path is successful. The path setting unit 610 sets the backup path at the lower layer based on the information about the protection recovery type if determined to set the backup path at the lower layer, and transmits a path failure message to the transmitting node if the setting of the backup path at the lower layer is failed.

The protection switching unit 620 is configured, if a fault at the lower layer is sensed, to perform a protection switching through the backup path of the lower layer that is set through the path setting unit 610.

In accordance with an embodiment of the present disclosure, the protection switching unit 620 is configured, if a fault at a lower layer is sensed, to determine whether a backup path is set at a lower layer. The protection switching unit 620, if determined that the backup path is set at the lower layer, performs a protection switching through the backup path at the lower layer, and if the backup path at the lower layer is not set, performs a protection switching through a backup path at an upper layer.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of recovering a fault in a multilayer network, the method comprising:
obtaining lower layer backup path setting information through a signaling message that is used for a label based path setting;
setting a backup path at a lower layer based on the obtained lower layer backup path setting information; and
upon detecting a fault at the lower layer, performing a protection switching through the set backup path at the lower layer.

2. The method of claim 1, wherein the lower layer backup path setting information comprises at least one of information whether to set a backup path at a lower layer, information about a protection recovery type, and information about a processing method at a failure of the setting of a backup path at a lower layer.

3. The method of claim 2, wherein the information whether to set the backup path at the lower layer is divided into a no-setting of a backup path at a lower layer, a setting of a backup path at a lower layer if an available resource for setting the path is present when the backup path at the lower layer is set, a no-setting of a backup path at a lower layer if an available resource for setting the path is not present when the backup path at the lower layer is set, and a failure of an entire path setting if the setting of the backup path is failed due to an absence of an available resource when the backup path at the lower layer is set.

4. The method of claim 1, wherein the lower layer backup path setting information is defined in a data frame format.

5. The method of claim 1, wherein the setting of the backup path at the lower layer comprises:
setting a working path at a lower layer;
transmitting a path setting failure message to a transmitting node if the setting of the working path at the lower layer is failed, and determining whether to set a backup path at the lower layer if the setting of the working path is successful;
setting the backup path at the lower layer based on the information about a protection recovery type if determined to set the backup path at the lower layer; and
transmitting a path failure message to the transmitting node if the setting of the backup path at the lower layer is failed.

6. The method of claim 1, wherein the performing of the protection switching comprises:
if a fault at a lower layer is sensed, determining whether a backup path is set at a lower layer; and
if the backup path at the lower layer is set, performing a protection switching through the backup path at the lower layer, and if the backup path at the lower layer is not set, performing a protection switching through a backup path at an upper layer.

7. The method of claim 1, wherein in the setting of the backup path at the lower layer, if a lower layer backup path no-setting option is set in the obtained lower layer backup path setting information, the backup path is not set at the lower layer.

8. The method of claim 1, wherein in the setting of the backup path at the lower layer, if a lower layer backup path setting option is set in the obtained lower layer backup path setting information, it is determined whether an available resource required to set the path at the time of setting the backup path at the lower layer is present, and if the available resource is present, the backup path is set at the lower layer, and if the available resource is not present, the backup path is not set at the lower layer.

9. The method of claim 1, wherein in the setting of the backup path at the lower layer, if the setting of the backup path is failed due to the absence of an available resource required to set the path at the time of setting the backup path at the lower layer, an entire path setting is determined to be failed and a path setting failure message is transmitted to a transmitting node.

10. The method of claim 1, wherein the signaling message is a path request message based on a resource reservation protocol.

11. An apparatus for recovering a fault in a multilayer network, the apparatus comprising:
a signaling process unit configured to analyze lower layer backup path setting information of a received signaling message;
a path setting unit configured to set a backup path at a lower layer based on the lower layer backup path setting information that is analyzed through the signaling process unit; and
a protection switching unit configured, if a fault at the lower layer is sensed, to perform a protection switching through the backup path of the lower layer that is set through the path setting unit.

12. The apparatus of claim 11, wherein the lower layer backup path setting information comprises at least one of information whether to set a backup path at a lower layer, information about a protection recovery type, and information about a processing method at a failure of the setting of a backup path at a lower layer.

13. The apparatus of claim 12, wherein the information whether to set the backup path at the lower layer is divided into a no-setting of a lower layer backup path, a setting of a lower layer backup path if an available resource for setting the path is present when the backup path at the lower layer is set, a no-setting of a lower layer backup path if an available resource for setting the path is not present when the backup path at the lower layer is set, and a failure of an entire path setting if the setting of the backup path is failed due to an absence of an available resource when the backup path at the lower layer is set.

14. The apparatus of claim 11, wherein the path setting unit is configured to set a working path at a lower layer, transmit a path setting failure message to a transmitting node if the setting of the working path at the lower layer is failed, determine whether to set a backup path at the lower layer if the setting of the working path is successful, set the backup path at the lower layer based on information about a protection recovery type if determined to set the backup path at the lower layer, and transmit a path failure message to the transmitting node if the setting of the backup path at the lower layer is failed.

15. The apparatus of claim 11, wherein the protection switching unit, if a fault at a lower layer is sensed, is configured to determine whether a backup path is set at a lower layer, and if the backup path at the lower layer is set, perform a protection switching through the backup path at the lower layer, and if the backup path at the lower layer is not set, perform a protection switching through a backup path at an upper layer.
